(19) United States
(12) Patent Application Publication
(10) Pub. No.: US 2026/0221819 A1
(43) Pub. Date: Jul. 30, 2026

(54) ELECTROMAGNETIC CORES, PUMPS USING THE SAME, AND METHODS OF MANUFACTURING THE SAME

(71) Applicant: GE-Hitachi Nuclear Energy Americas LLC, Wilmington, NC (US)

(72) Inventors: Scott A. Wagner, Grosse Pointe Park, MI (US); Nikolas R. Davis, Tulsa, OK (US)

(21) Appl. No.: 19/040,842

(22) Filed: Jan. 29, 2025

(51) Int. Cl. H02K 1/16; H02K 1/02; H02K 3/34; H02K 15/021

(52) U.S. Cl. CPC H02K 1/165; H02K 1/02; H02K 3/34; H02K 15/021

(57) ABSTRACT

Systems and methods use bodies with internal columns following a magnetic field enhanced by the same. The columns have adjacent gaps while the body remains a continuous rigid structure. The gaps may be any shape or size formed by removal from the parent body while preserving a continuous joining portion of the body that may form a flow channel wall in an example embodiment pump. The body may take on any shape or size, including electromagnetic pump stator configurations. Example systems and methods require fewer additional joining or supporting structures due to flow passage walls already being present in cores from fabrication.

### BACKGROUND

FIG. 1 is a perspective view of a related art stator core 1, such as an inner stator core useable in a linear electromagnetic pump. As seen in FIG. 1, stator core 1 is made up of several lamination sections 10 joined to an inner guide 11. FIG. 2 illustrates lamination section 10 in greater detail, showing it is assembled of multiple discreet sheets 15 each punched or machined from a parent ferromagnetic source. Each sheet 15 may be coated with insulation or have insulation filled between adjacent sheets 15.

Multiple sheets 15, potentially fifteen, twenty, or more, are aligned and joined by tie rod 16 passing through sheets 15 and holding them as a single lamination section 10. End pieces 17 allow tie rods 16 to anchor and secure the separate sheets 15 together, such that section 10 acts as a rigid, modular body with all sheets 15 kept in alignment.

FIG. 3 is an axial cross-section of a related art electromagnetic pump 20 using related art stator core 1. Outer stator core 2 may be positioned about inner stator core 1 to form an annular channel 22. Outer stator core 2 is also made up of lamination sections 10 similar to inner stator core 1, with each section being joined to structural support 5. Pump case 21 surrounds stators 1 and 2 and guides fluid into annular channel 22. As current is run through induction coils passing in a circular direction within stator cores 1 and 2, resultant magnetic fields in the ferromagnetic portions of the lamination sections 10 drive the fluid in channel 22 in an axial direction due to perpendicular electrical fields or current. U.S. Pat. No. 4,642,882 to Castiglione et al. ; U.S. Pat. No. 5,440,600 to Fanning; and U.S. Pat. No. 6,603,224 to Hollingsworth et al. ; and CN Patent 114,640,233 to Zhejiang University ZJU describe electromagnetic pumps having various stator configurations and/or methods of fabricating the same, and are incorporated by reference herein in their entireties.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include electromotive devices such as induction pumps and the like and magnetic cores useable as stator cores for the same and other electromagnetic devices. Example embodiment cores define several slots that divide the core into internal laminated sections of columns whose longest dimension aligns with a magnetic field enhanced by the core. The slots do not pass through both ends of the core, such that the core may be a single piece of material with integral continuity that does not require joining multiple pieces together or possess material mismatch. In this way an end of the core may be used as a flow channel for a pumped fluid, where a continuous, smooth surface of the core may provide containment and non-interaction with even a high-temperature fluid like liquid metals. In the example of a partially or complete annulus core, the slots may extend radially almost to both inner and outer radii of the same and completely axially. In this example, the continuous walls at the radii provide continuous surfaces for defining a flow channel. Recesses, depressions, and extensions in some surfaces may accommodate joining to other cores, potentially via joining structures like axial segments, as well as internal electronics and circuitry.

Thermal and/or electrical insulation, including solid insulating materials and air gaps, may be used in any slot, recess, or surface of example embodiment cores. A single piece of magnetic material, such as a ferromagnetic stainless steel, may be used for example embodiment cores, with example methods forming any slots or recesses in a core through forging, removal, extrusion, etc. the parent material.

Example embodiment pumps use an example embodiment stator core to define, at least in part, flow channels for a pumped fluid. Multiple cores may be joined along a single axis of flow and/or nested concentrically to define flow paths of any length and shape. Because the stator cores may have relatively smooth and strong material surfaces defining the path without material discontinuity, the pumped fluid may be in closer contact with magnetic fields in the pump while being contained at substantial temperatures and pressures. In the example of cylindrical or annular stator cores, example embodiment pumps may use annular flow channels between the stator cores. Multiple stator cores may be axially aligned, potentially bridging pieces with annular joining sections, to create a flow path of any desired length and passing entirely through a pump case.

### BRIEF DESCRIPTIONS OF THE DRAWINGS

Example embodiments will become more apparent by describing, in detail, the attached drawings, wherein similar elements are represented by similar reference numerals. The drawings serve purposes of illustration only and thus do not limit example embodiments herein. Elements in these drawings may be to scale with one another and exactly depict shapes, positions, operations, and/or wording of example embodiments, or some or all elements may be out of scale or embellished to show alternative proportions and details.

FIG. 1 is an illustration of a related art inner stator core using lamination sections.

FIG. 2 is a detail illustration of a related art lamination section.

FIG. 3 is an axial cross-section of a related art electromagnetic pump.

FIG. 4 is a cross-section view of an example embodiment electromagnetic pump.

FIG. 5 is a perspective view of an example embodiment outer stator core.

FIG. 6 is a detail view of the core of FIG. 5.

FIG. 7 is another detail view of the core of FIG. 5.

FIG. 8 is a side view of an axial stack of example embodiment cores.

FIG. 9 is a perspective view of an example embodiment inner stator core.

FIG. 10 is a detail view of the core of FIG. 8.

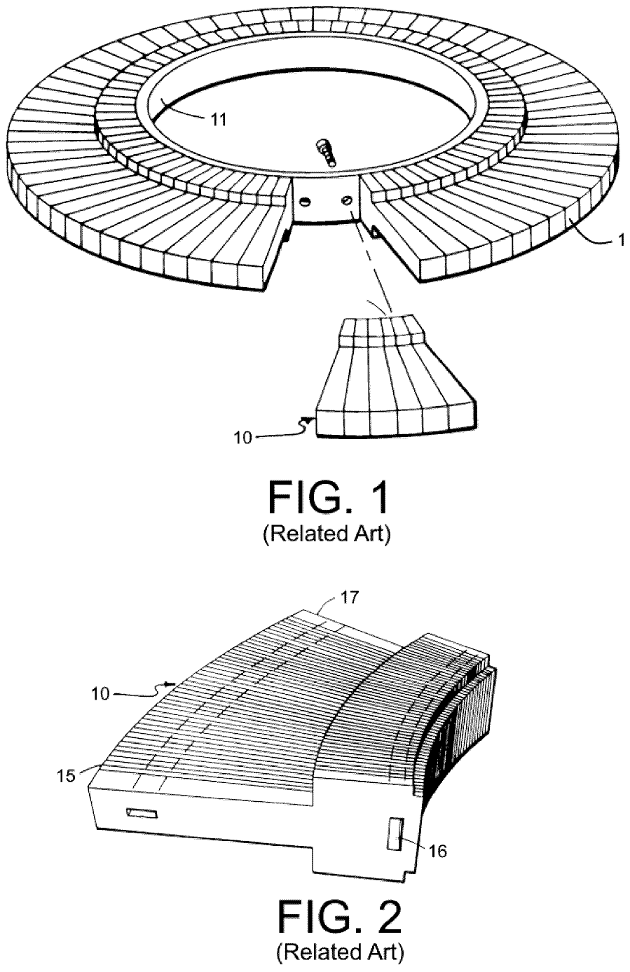

### DETAILED DESCRIPTION

Because this is a patent document, general broad rules of construction should be applied when reading it. Everything described and shown in this document is an example of subject matter falling within the scope of the claims, appended below.

Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein. Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion of non-listed items.

The use of “etc.” is defined as “et cetera” and indicates the inclusion of all other elements belonging to the same group of the preceding items, in any “and/or” combination(s).

Modifiers “first,” “second,” “another,” etc. do not confine modified items to any order.

These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

Proportions, sizes, and shapes shown in the figures are examples for illustration. While they reflect features of some example embodiments, other relationships and magnitudes of dimensions are included in these examples. As used herein, “azimuthal” and “angular” directions substantially follow a rounded perimeter of a referenced feature, and “radial” directions substantially follow a radius of that rounded perimeter, perpendicular to the angular direction. “Vertical” and height directions substantially follow an up-down orientation, orthogonal to the radial and angular directions of a referenced feature. “Length” and “width” are substantially perpendicular dimensions of a referenced feature, with “length” generally being a longest dimension of the feature.

The inventors have recognized that related art electromotive devices using laminated segments joined to separate duct walls require the laminated portions to be substantially separated from the fluid pumped through the device. This separation may reduce pump performance by permitting magnetic field attenuation over distance. The duct wall material may also slow and complicate heat conduction away from electronics and core components useable in the devices, by changing heat conduction speeds or directions or causing material interruptions due to differing heat expansion properties between a duct wall and core. The additional duct portions require additional effort and parts and represent additional failure points where the joining to the laminated portions requires additional work and may more easily come apart than a single piece of material. To overcome these newly-recognized problems as well as others, the inventors have developed example embodiments and methods described below to address these and other problems recognized by the inventors with unique solutions enabled by example embodiments.

The present invention is cores, electromagnetic devices using the same as stators, and methods of fabricating and using the same. In contrast to the present invention, the few example embodiments and example methods discussed below illustrate just a subset of the variety of different configurations that can be used as and/or in connection with the present invention.

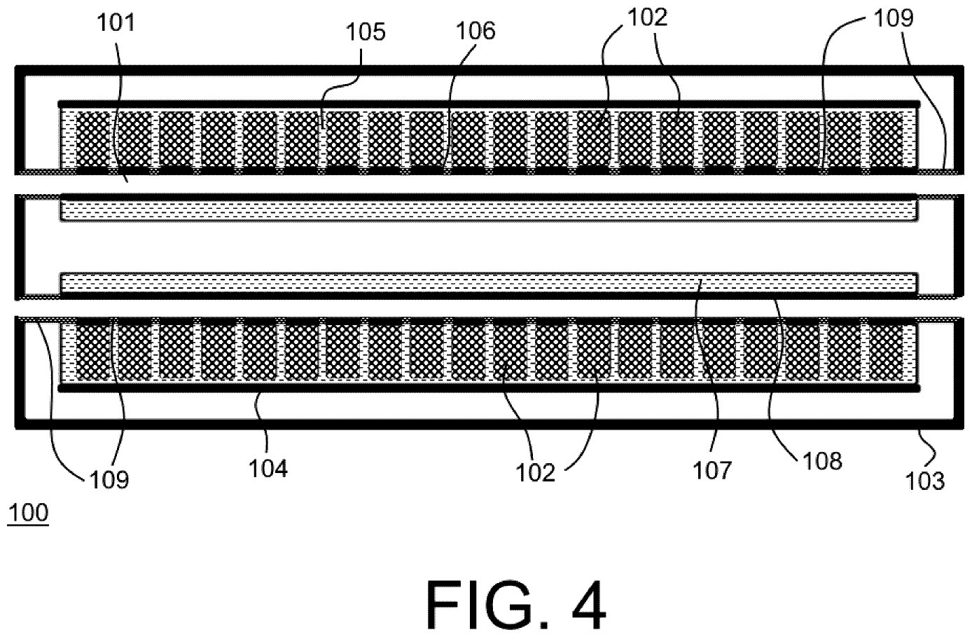

FIG. 4 is an illustration of an example embodiment electromagnetic pump 100. As seen in FIG. 4, conductive fluid flow moves through flow annulus 101 of pump 100. Several stators or coils 102 may surround annulus 101 and drive flow through induction upon receiving a drive current. Outer stator cores 105 and/or inner stator cores 107 may enhance flow under the force of the induced magnetic field, and may be fabricated of a ferromagnetic material, such as ferromagnetic stainless steel. Pump case 103 may contain electronics and insulation in a package with the remainder of the internals of example embodiment pump 100. Example embodiment electromagnetic pump 100 may have any flow shape and case size as existing electromagnetic pumps, and/or be useable in place of any electromagnetic pump, including those found in US Pat Pub 2020/0403555 to Mills; US Pat Pub 2011/0280737 to Sarkinen et al. ; CA Pat Pub 3187103 to Corbin; US Pat Pub 2003/0102352 to Aizawa et al. ; and US Pat Pub 2022/0372973 to Dupeu et al., U.S. patent application Ser. No. 18/428,629 filed Jan. 31, 2024 by Meek et al. for ELECTROMAGNETIC PUMPS AND METHODS OF OPERATING THE SAME WITH IMPROVED COOLING, and U.S. patent application Ser. No. 18/765,238 filed Jul. 6, 2024 by Wagner et al. for ELECTROMAGNETIC CORES, PUMPS USING THE SAME, AND METHODS OF MANUFACTURING THE SAME, all incorporated by reference herein in their entireties.

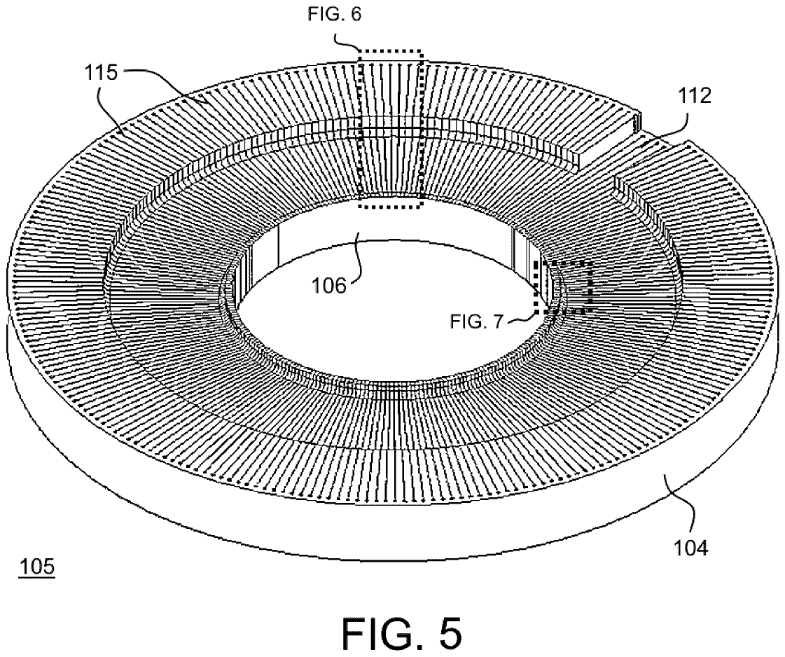

Example embodiment pumps and other electromotive devices may use example embodiment cores formed from parent or blank magnetic materials. Example embodiment cores may be fabricated from a variety of parent ferromagnetic materials, including sheets, billets, annuli, etc. that are forged, annealed, cast, cut, or otherwise shaped in a starting parent shape. FIG. 5 is an illustration of an example embodiment outer stator core 105 useable in an electromagnetic device, including electromagnetic pumps. Although core 105 is shown as a complete annulus in FIG. 5, it is understood that other shapes and sections are useable for core 105, based on the shape of the parent material from which core 105 is cut, such as with forging, cutting, and/or machining.

Example embodiment outer stator core 105 may be fabricated of any magnetic material, including magnetic steel optimized for magnetic performance through metallurgical standards or ferromagnetic materials like ferritic stainless steels.

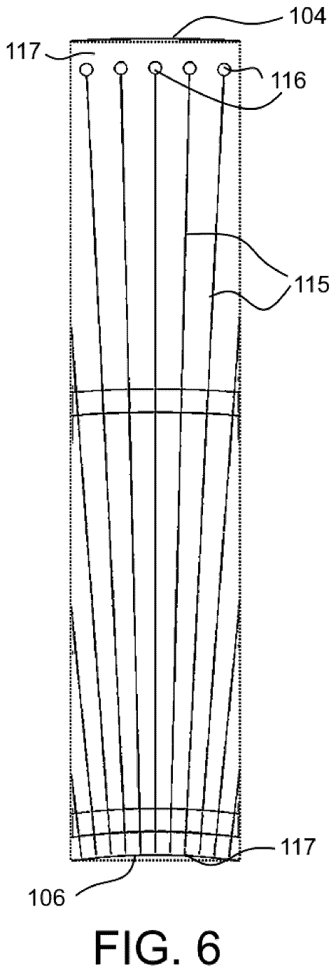

As shown in FIG. 5, example embodiment core 105 includes several radial slots 115 cut a full axial height and nearly a full radius of core 105. Radial slots 115 form lamination sections between the slots, which are columns extending longest in a dimension associated with a radial magnetic field of the core. As shown in FIG. 6, outer solid section 104 and/or inner solid section 106 may join all lamination sections at edges of core 105. Although slots 115 may be any length into core 105, longer slots, with solid sections 117 remaining only of a thickness sufficient to provide rigid strength for core 105, may best prevent angular or azimuthal currents from flowing through laminated portions. For example, slots 115 may extend about 80% or more in a radial direction of core 105, or even over 90% of a radial thickness of core 105, and solid sections 117 may be relatively small, such as only 0.25 in thick in common stator applications.

As shown in FIG. 6, solid section 117 at a lower portion of the core may form solid channel wall 106. For example, channel wall 106 may be a smooth vertical side of core 105, such as a continuous material barrier across an entire inner annulus wall of the core. Channel wall 106 may also form one transverse edge of flow annulus 101 (FIG. 4) in an electromagnetic pump. In this example, channel wall 106, and potentially all of example embodiment core 105 may be formed of a material compatible with a fluid expected to be pumped through the annulus, including, for example, stainless steels capable of directly contacting molten materials and liquid metals pumped by an electromagnetic pump, such as liquid sodium, without significant degradation. Thickness of solid section 117 may be sufficient to contain a pumped fluid under pump operating pressures and temperatures while thin enough to place the driving magnetic fields directly into the fluid in flow annulus 101 (FIG. 4). Channel wall 106 may further directly conduct heat from a pumped fluid into cores 105 (FIG. 4) for heat dissipation away from coils 102 and/or other electrical elements.

Solid section 117 at an upper portion may form external continuous wall 104 (FIG. 4). If the opposite solid section 117 is kept to a minimum thickness, such as fractions of an inch sufficient only to contain a pumped fluid, solid section 117 at an upper portion may provide sufficient strength and rigidity to the overall core, and potentially bear axial loads for connection, through connected cores. In these example configurations, solid section 117 at an upper portion may be radially larger than solid section 117 at a lower portion; that is, external wall 104 may be thicker than channel wall 106.

Slots 115 may be of any number, pitch, and thickness, with resulting characteristics laminated columns. For example, each slot 115 may be cut, such as through electrical discharge machining, wire EDM, water jet, band saw, and/or laser cutting, from a solid magnetic material. If solid section 117 are present at both ends of slots 115, access cuts 116, such as a drilled hole, borehole, or larger laser hole, may be used to allow entry of any necessary machining to form slot 115 from access cut 116.

Precision machining may allow slots 115 be thin, such as 0.01 down to 0.0001-inches, in an azimuthal or angular direction of core 105. This thickness may be perpendicular to the radial distance or length of slots 115 discussed above. The pitch of slots 115 may be chosen based on a desired operating frequency of a stator and/or pump in which core 105 may be used. For example, slots 115 may be spaced every 0.05-0.1 inches, such that teeth 102 have that thickness. This may result in dozens, or hundreds, of laminations formed by magnetic columns across an inner perimeter of core 105.

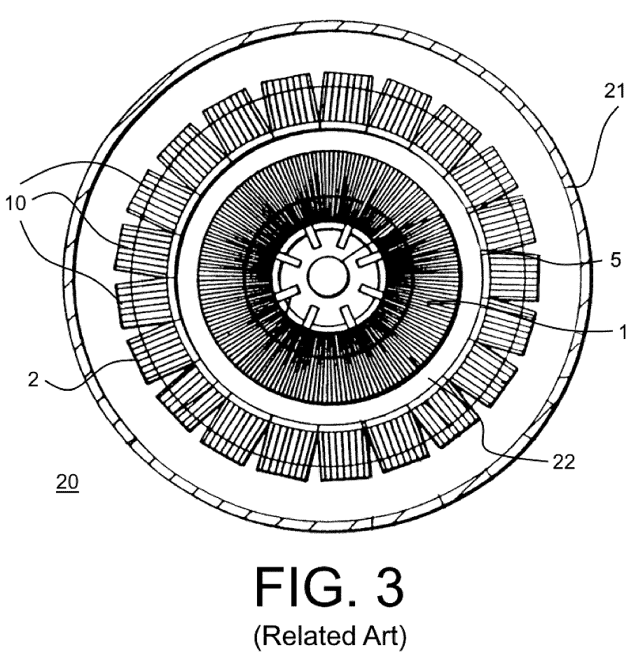

While slots 115 may be substantially straight with uniform shapes and size, these may also be varied in individual slots 115 to form differing lamination column shapes. For example, angled, curved, and/or wavy slots 115 with individually uniform or varying height and width may be used, and resulting columns may be different sizes or shapes from one another. These different shapes and sizes may be chosen to accommodate additional elements between or through core 105 such as powering coils, insulation, or any other element, as well as to vary and achieve desired magnetic properties of the same. As seen in FIG. 5, example embodiment core 105 may include slots 115 arrayed along an entire angular distance of core 105. In the example of an annular core, this may form a complete or partial circle of slots 115. Compared to the related art lamination sections 10 seen in FIG. 3, example embodiment core 105 has fewer gaps and parts, with denser ferromagnetic material positioned around core 105 having no such gaps. Moreover, example embodiment core 105 may not include any separate joining piece or assembly, because after being cut to solid sections 117 (FIG. 6), core 105 remains integral and a rigid structure, potentially without internal discontinuity or separate joining structures.

Insulation may be filled in slots 115 to impart desired heat and/or electrical isolation/transfer columns in a core. Any dielectric material may be used for insulation, including air allowed to pass into open slots 115. Insulation that forms or is a solid material may be introduced on sides of slots 115 through vapor deposition, plating, water-based solutions such as a water-based aluminum oxide coating, vacuum fill, oxidation, paint on and then bake, etc. to achieve desired uniformity and heat and electrical properties in slots 115 between columns. Similarly, insulating materials may be placed on tops and bottoms of example embodiment core 105, potentially surrounding its exterior.

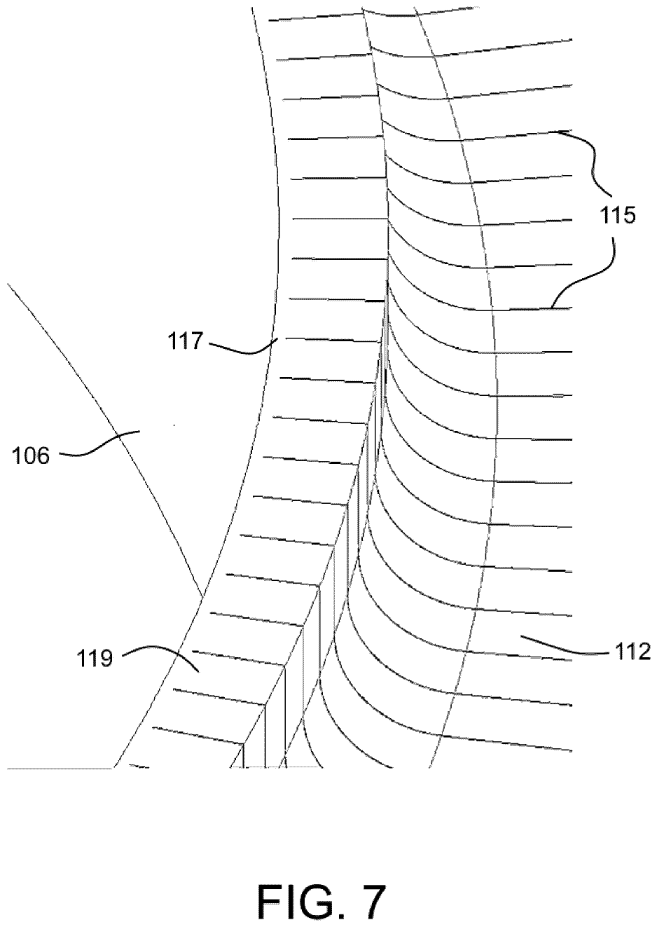

As shown in FIGS. 5 and 7, example embodiment core 105 may include a shaped recess 112 or space for other stator electronics. For example, recesses 112 may match between cores 105 stacked axially as in FIG. 4, which may form complete angular or perimeter channels for coils, as well as a radial entry for such coils, to induce magnetic field and operate cores 105 as stators. Recesses 112 may be machined, laser cut, etched, etc. from core 105, before or after the formation of slots 115 and remainder of core 105 from a parent magnetic material. Recesses 112 may compliment each other across cores 105 when stacked or otherwise aligned, such as to form radial passages or openings to allow induction coils to pass into and out of stack of cores 100. For example, in FIG. 4, by running electrical current in coils 102 a radial direction through passages formed by recesses 112, electromagnetic flow may be induced in flow channel 101 using stacked example embodiment cores 105 as an outer stator in an electromagnetic pump.

As seen in the detail of FIG. 7, example embodiment core 105 may include a rise, flange, or other connection annulus 119 that extends axially upward to provide a uniform joining point to channel wall 106. For example, connection annulus 119 may be an upward projection remaining after the removal of recess 112 and extend across an entire inner perimeter of channel wall 106. Slots 115 may extend through connection annulus 119 to solid section 117.

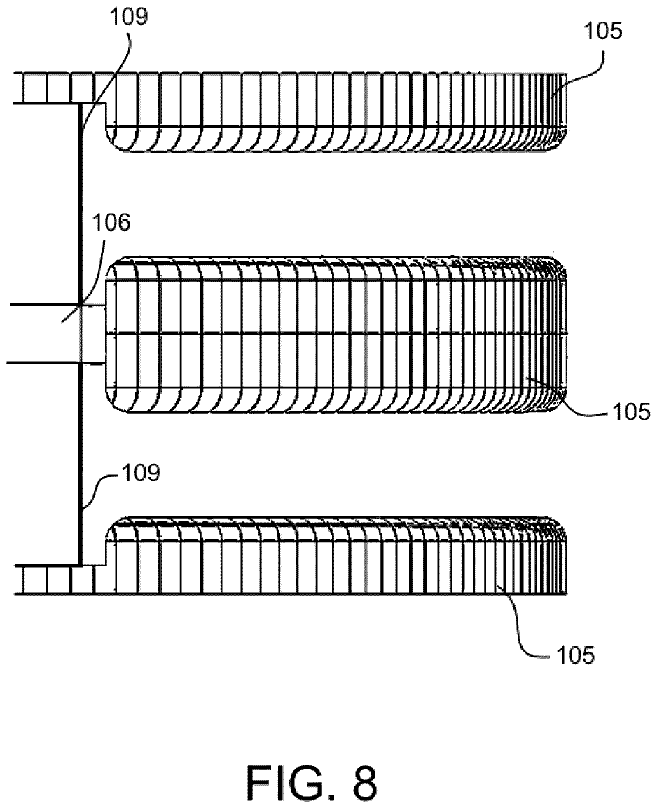

FIG. 8 illustrates an example embodiment pump configuration where multiple cores are joined to form a continuous flow path wall. For example, several example embodiment cores 105 may form adjacent potions of cores 105 shown in FIG. 4. As shown in FIG. 8, cores 105 may be aligned about their central axis and joined by axial segments 109. For example, axial segments 109 may be welded or forged to connection annulus 119 (FIG. 7) about an entire inner surface perimeter. Axial segments 109 may not be ferromagnetic but magnetically permeable, such as 316 stainless steels for example, to avoid interference with any magnetic field.

Axial segments 109 may seamlessly continue channel wall 106 (FIG. 5), thus forming a continuous wall of flow annulus 101. Any number of cores 105 may be joined in this fashion, with axial segments 109 joining each side of each core. In the example of FIG. 4, over a dozen axial segments 109 are used to join walls 106. Axial segments may further join to pump case 103 to provide entrance and exit paths to/from an example embodiment electromagnetic pump and flow paths therein.

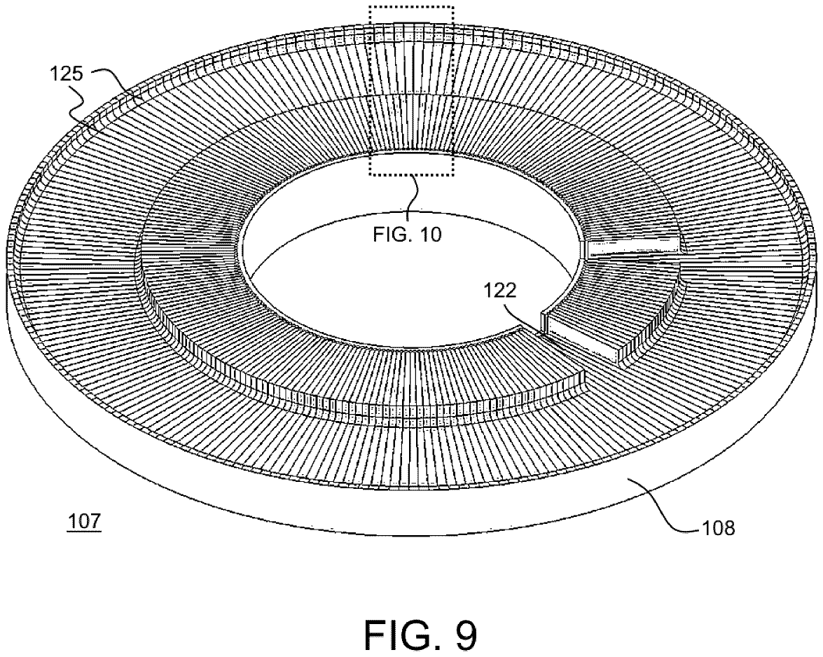

FIG. 9 is an illustration of another example embodiment core 107 useable as inner stator cores in an electromagnetic device, including example embodiment electromagnetic pump 100. Like core 105, example embodiment core 107 may be fabricated of any magnetic material, including metal alloys, solid iron and/or ferritic stainless steel. Although core 107 is shown as a complete annulus in FIG. 9, it is understood that other shapes and sections are useable for core 107, given the shape of the magnetic material from which it is formed by forging, cutting, and/or machining.

As shown in FIG. 9, core 107 includes several radial slots 125 cut an entire axial height and nearly a full radius of core 107. Radial slots 125 form columns or laminations between the slots, extending longest in a dimension associated with a radial magnetic field. Solid sections 127 may join all columns at an inner or furthermost position from a start of slots 125. Although slots 125 may be any radial length into core 107, longer slots, with solid sections 127 remaining only of a thickness sufficient to provide rigid strength for core 107, may best prevent angular or azimuthal currents from flowing through solid section 127 and different columns. For example, slots 125 may extend about 80% or more, such as over 90%, of a radial thickness of core 107.

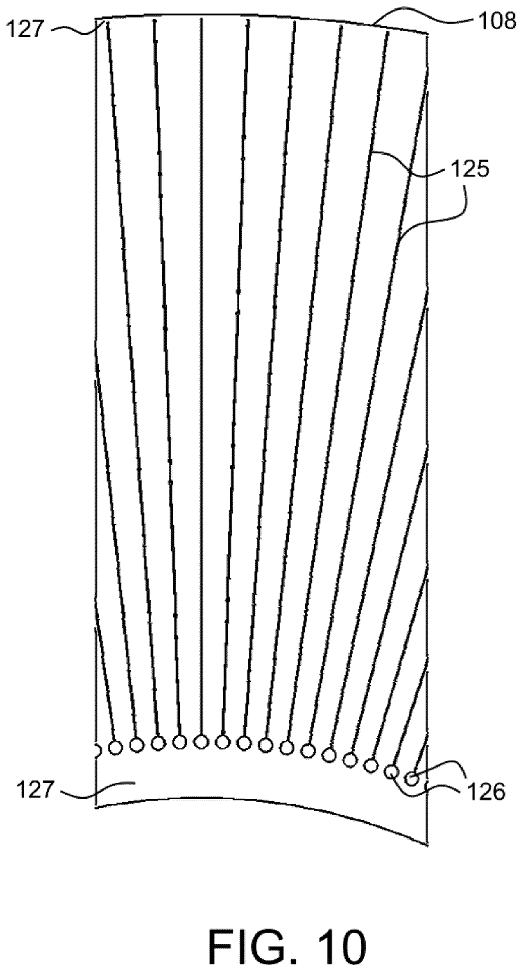

As shown in FIG. 10, solid section 127 at an outer portion of the core may form solid channel wall 108. For example, channel wall 108 may be a smooth and/or continuous material barrier across a partial or complete outer annulus wall of core 107. Channel wall 108 may form one transverse edge of flow annulus 101 (FIG. 4) in an electromagnetic pump. In this example, channel wall 108, and potentially all of example embodiment core 107 may be formed of a material compatible with a fluid expected to be pumped through the annulus, including, for example, stainless steels capable of contacting molten materials and liquid metals pumped by an electromagnetic pump, such as liquid sodium. Thickness of solid section 127 may be sufficient to contain a pumped fluid under pump operating pressures and temperatures while thin enough to place the driving magnetic fields directly into the fluid in flow annulus 101 (FIG. 4).

Channel wall 108 may further directly conduct heat from a pumped fluid into cores 107 (FIG. 4) for heat dissipation. If one wall is kept to a minimum thickness, such as fractions of an inch sufficient only to contain a pumped fluid, the opposite wall may provide sufficient strength and rigidity to the overall core, and potentially bear axial loads for connection, through connected cores. In these example configurations, solid section 127 at an inner portion may be radially larger than one at an outer portion.

Slots 125 may be of any number, pitch, and thickness, with resulting characteristics laminated columns. For example, each slot 125 may be cut, such as through electrical discharge machining, wire EDM, water jet, band saw, and/or laser cutting, from a solid magnetic material. If solid sections 127 are present at both ends of slots 125, access cuts 126, such as a drilled hole, borehole, or larger laser hole, may be used to allow entry of any necessary machining to form slot 125 from access cut 126.

Precision machining may allow slots 125 be thin, such as 0.01 down to 0.0001-inches, in an azimuthal or angular direction of core 107. This thickness may be perpendicular to the radial distance or length of slots 125 discussed above. The pitch of slots 125 may be chosen based on a desired operating frequency of a stator and/or pump in which core 107 may be used. For example, slots 125 may be spaced every 0.05-0.1 inches, such that columns have that thickness. This may result in dozens, or hundreds, of laminations formed by magnetic columns across an inner perimeter of core 107.

While slots 125 may be substantially straight with uniform shapes and size, these may also be varied in individual slots 125 to form differing lamination column shapes. For example, angled, curved, and/or wavy slots 125 with individually uniform or varying height and width may be used, and resulting columns may be different sizes or shapes from one another. These different shapes and sizes may be chosen to accommodate additional elements between or through core 107 such as powering coils, insulation, or any other element, as well as to vary and achieve desired magnetic properties of the same. As seen in FIG. 9, example embodiment core 107 may include slots 125 arrayed along an entire angular distance of core 107. In the example of an annular core, this may form a complete or partial circle of slots 125. Compared to the related art lamination sections 10 seen in FIG. 3, example embodiment core 107 has fewer gaps and parts, with denser ferromagnetic material positioned around core 107 having no such gaps. Moreover, example embodiment core 107 may not include any separate joining piece or assembly, because after being cut to solid sections 127 (FIG. 10), core 107 remains integral and a rigid structure, potentially without internal discontinuity or separate joining structures.

Insulation may be filled in slots 125 to impart desired heat and/or electrical isolation/transfer columns in a core. Any dielectric material may be used for insulation, including air allowed to pass into open slots 125. Insulation that forms or is a solid material may be formed on sides of slots 125 through vapor deposition, plating, water-based solutions such as a water-based aluminum oxide coating, vacuum fill, oxidation, paint on and then bake, etc. to achieve desired uniformity and heat and electrical properties in slots 125 between columns. Similarly, insulating materials may be placed on tops and bottoms of example embodiment core 107, potentially surrounding its exterior.

As shown in FIG. 9, example embodiment core 107 may include a shaped recess 122 or space for other stator electronics. For example, recesses 122 may match between cores 107 stacked axially as in FIG. 4, which may form complete angular or perimeter channels for coils, as well as a radial entry for such coils, to induce magnetic field and operate cores 107 as stators. Recesses 122 may be machined, laser cut, etched, etc. from core 107, before or after the formation of slots 125 and remainder of core 107 from a parent magnetic material. Recesses 122 may complement each other across cores 107 when stacked or otherwise aligned, such as to form radial passages or openings to allow induction coils to pass into and out of stack of cores 107.

Multiple cores 107 may similarly be joined like cores 105 to form a continuous flow path wall. For example, several example embodiment cores 107 may form adjacent potions of cores 107 shown in FIG. 4. Example embodiment cores 107 may be welded or forged directly to one another about an entire outer surface perimeter. Channel wall 108 from adjacent joined cores 107 may form a continuous wall of flow annulus 101. Any number of cores 107 may be joined in this fashion, such as in near equal numbers or more of joined cores 105 that may form an opposite wall of flow channel 101. Axial segments 109 may further join to pump case 103 to provide entrance and exit paths to/from an example embodiment electromagnetic pump and flow paths therein.

Example embodiment cores 105 and 107, including any reshaping or resizing thereof, are useable as stators or magnetic elements, as well as flow path structures directly contacting and containing a pumped fluid in a wide array of electromagnetic devices. For example, cores 105 and 207 could be used as outer and inner stators while simultaneously forming annular flow channel 101 between their solid walls, with coils running through them providing inductive current, in electromagnetic pumps. Cores 105 or 107 may be shaped, sized, and otherwise configured to accommodate any flow shape and case size, to replace known stators in existing electromagnetic pumps, and/or replace stators at the fabrication of any electromagnetic pump, including those in the incorporated documents.

Example cores further reduce the need for assembly and combining parts, where they may be a single integral piece of rigid material. In this way, example cores can be formed into more complex and customized shapes without attendant increases in support and joining structures. Because example embodiments may be formed through relatively simple cutting only, fabrication costs of assembling individual teeth in lamination packs may be avoided. In these and other ways, example embodiment cores may lower fabrication costs while boosting performance of electromagnetic devices.

The inventors verified the performance of example embodiment cores used as inner and outer electromagnetic pump stators. Pumped fluid pressure and efficiency of pumping in particular were analyzed versus related art lamination packs that generally require larger, thicker duct walls to hold all laminations together. When example embodiment eliminated about 80% or more of the duct wall thickness, pump performance in terms of pressure of fluid pumped and pump efficiency improved over related lamination pack designs.

Example embodiment cores may use any materials compatible with an operating nuclear reactor environment, including radiation-resilient materials that maintain their physical characteristics when exposed to high-temperature fluids, liquid metals, and radiation without substantially changing in physical properties, such as becoming substantially radioactive, melting, brittling, retaining/adsorbing radioactive particulates, etc. For example, magnetic materials, including iron and ferritic stainless steels, as well as inert and high-temperature insulations including air gaps, are useable for cores and components interacting with the same at several hundred degrees Celsius. Conductive, high-temperature materials including insulated and plated copper and/or nickel are similarly useable for coil in example embodiment pumps using example cores as stators. Similarly, direct connections between distinct parts and all other direct contact points may be lubricated, insulated, and/or fabricated of alternating or otherwise compatible materials to prevent seizing, fouling, metal-on-metal reactions, conductive heat loss, etc.

Some example embodiments and methods thus being described, it will be appreciated by one skilled in the art that examples may be varied through routine experimentation and without further inventive activity. For example, although some annular shapes and sections of cores are the target of some example embodiments and methods, it is understood that any other shapes and sizes are useable with example embodiments and methods. Variations are not to be regarded as departure from the spirit and scope of the example embodiments, and all such modifications as would be obvious to one skilled in the art are intended to be included within the scope of the following claims. The following is a complete, marked-up listing of revised claims with a status identifier in parenthesis, underlining indicating insertions, and strikethrough and/or double-bracketing indicating deletions. Listing of Claims

1. An electromagnetic pump comprising
the stator of claim 11, wherein the stator of claim 11 is an outer stator core having a solid section joining all columns, wherein the solid section and the columns are materially continuous; and
an inner stator core having columns aligned with a magnetic field of the inner stator core, wherein each column is formed by directly adjacent slots passing a full height of the inner stator core, and a solid section joining all columns, wherein the solid section and the columns are materially continuous, and wherein the solid section of the outer stator core and the solid section of the inner stator core form one or more sides of a flow passage though the pump configured to direct and contain a fluid pumped by the pump.

2. The pump of claim 1, wherein the slots of the outer stator core and the inner stator core do not reach an edge extending the height of the stator cores.

3. The pump of claim 2, wherein the inner stator core and the outer stator core are annular, and wherein none of the slots reach an inner radius or outer radius of the cores.

4. The pump of claim 1, further comprising:
a plurality of the outer stator cores all axially aligned; and
a plurality of annular sections joining the outer stator cores, wherein one of the two sides of the flow passage are formed by alternating annular sections and solid sections of the outer stator cores.

5. The pump of claim 4, further comprising:
a plurality of the inner stator cores all axially aligned and coaxial with one of the outer stator cores, wherein another of the two sides of the flow passage are formed by solid sections of the inner stator cores directly joined.

6. The pump of claim 1, wherein the outer stator core and the inner stator core are annular and coaxial, and wherein the inner stator core is sized to fit within an inner opening of the outer stator core, and wherein the flow passage is an annulus between the inner stator core and the outer stator core.

7. The pump of claim 6, wherein the slots extend in a radial direction of the annuli, and wherein the solid section is at at least one end the slots in the radial direction.

8. The pump of claim 7, wherein the slots extend at least 80% of each of the cores in the radial direction.

9. The pump of claim 1, further comprising:
solid insulation within at least one of the slots.

10. The pump of claim 1, wherein the inner stator core and the outer stator core are each single pieces of ferromagnetic stainless steel, and wherein the slots are formed by at least one of electrical discharge machining, jetting, and wire cutting the single pieces.

11. A core for use in an electromagnetic device, the core comprising:
a single piece of magnetic material having a plurality of slots extending completely through the material in only a single dimension so as to define internal columns of the material aligned with a magnetic field of the material.

12. The core of claim 11, wherein the material is ferromagnetic stainless steel, and wherein the slots are each up to 0.01-inches in a smallest dimension.

13. The core of claim 11, wherein the material is annular defined by an inner radius, and an outer radius, and a height, and wherein the slots extend through the material entirely in a direction of the height and do not reach the inner radius or the outer radius.

14. The core of claim 13, wherein edges of the material at the inner radius and edges of the material at the outer radius are smooth and continuous.

15. The core of claim 13, wherein the material has a recess in extending a partial height of the material that includes a passage to the inner radius to form an external entry for a coil passage.

16. The core of claim 11, further comprising:
solid insulation within at least one of the slots.

17. An electromotive device comprising a plurality of the cores of claim 11 axially joined, wherein the cores define a flow path in the device.

18-20. (canceled)

21. The core of claim 11, wherein the material forms an annulus, and wherein the slots each extend along a radius of the annulus, and wherein each of the slots is positioned at a distinct angular position within the annulus.

22. The core of claim 21, wherein the slots are evenly distributed across an entire angular dimension within the annulus.

23. The core of claim 11, wherein the core excludes any tie rod joining the material or any joined laminations of core segments.
